(19) United States
(12) Patent Application Publication
(10) Pub. No.: US 2025/0372935 A1
(43) Pub. Date: Dec. 4, 2025

(54) DISTRIBUTED FILTERS FOR SUPPRESSION OF PARASITIC PROCESSES IN FIBER LASER SYSTEMS

(71) Applicant: nLIGHT, Inc., Camas, WA (US)

(72) Inventor: Tyson L. Lowder, Vancouver, WA (US)

(21) Appl. No.: 19/222,967

(22) Filed: May 29, 2025

Related U.S. Application Data
(60) Provisional application No. 63/653,683, filed on May 30, 2024.

(51) Int. Cl. H01S 3/08; H01S 3/067; H01S 3/108; H01S 3/23

(52) U.S. Cl. CPC H01S 3/08013; H01S 3/108; H01S 3/2308; H01S 3/067; H01S 2301/02

(57) ABSTRACT

A length of optical fiber suppresses a nonlinear optical process so as to inhibit energy transfer away from a desired laser wavelength. The fiber has a core and a cladding designed to propagate a laser beam at the desired wavelength, alongside a nonlinear laser component having intensity that escalates as a function of distance due to the nonlinear optical process; a series of spaced-apart filters, each configured with a transmission level to redirect a proportion of the nonlinear laser component from the core into the cladding so as to collectively control exponential growth in the intensity of the nonlinear laser component by imparting resets in the intensity at predetermined intervals along the length; and an output configured to provide the laser beam following its suppressed escalation of the intensity and preservation of energy of the laser beam at the desired wavelength.

### CROSS-REFERENCE TO RELATED APPLICATION(S)

This United States Non-Provisional Patent Application relies on and claims priority to U.S. Provisional Patent Application Ser. No. 63/653,683, filed on May 30, 2024, the entire contents of which are incorporated herein by reference.

### TECHNICAL FIELD

The technology disclosed herein relates to fiber lasers and fiber-coupled lasers. More particularly, the disclosed technology relates to stimulated Raman scattering (SRS) and other nonlinear optical process filters.

### BACKGROUND INFORMATION

There are several parasitic processes that can occur in a fiber laser or fiber amplifier system that either transfer energy away from the desired laser wavelengths or inhibit the efficient amplification of the desired laser energy. Some examples of these processes could be stimulated Raman scattering (SRS) or amplified spontaneous emission (ASE). Due to the detrimental effects of these processes, there is a desire to suppress them as efficiently as possible. Effective suppression these effects allows for longer fibers and provides for scaling up power levels, maintaining beam quality, and ensuring stability in laser systems.

The present applicant, nLIGHT, Inc., has developed innovative methods for managing SRS in industrial fiber lasers. Pub. No. US 2022/0085567 A1 of nLIGHT, Inc. describes fiber laser devices, systems, and methods for reducing Raman spectrum in emissions from a resonant cavity. For example, FIG. 5A of the '567 publication shows a superstructure fiber grating (SS-FG) that may be employed as a reflective Raman filter and a laser resonator output coupler. The SS-FG can produce multiple reflection peaks from a single grating writing process that does not rely on multiple phase masks. In the spectrum, the reflection peak spacing is given by:

$$Δλ = \frac{λ {Bragg}^{2}}{2 * neff * P} ,$$

where P is the period, defined by the physical length of a single grating plus the non-grating gap before the next grating. In practice P is on the order of hundreds of microns to give reflection channel spacings on the order of nanometers. As P is decreased, the reflection peak channel spacing gets larger and as P is increased the reflection peak channel spacing decreases.

The SS-FG may occupy considerably less fiber length than would fiber Bragg gratings (FBGs) having separate phase masks (i.e., one for the output coupler and one for the filter). Thus, a single SS-FG could be written with a single phase mask by either scanning the phase-mask and modulating the laser on and off at the appropriate period, or by masking off the phase mask at the appropriate period. The appropriate period would be such that there is a strong reflection peak at the SRS wavelength for filtering of the parasitic energy and then a much less reflective peak at the desired laser wavelength to be used as the laser resonator output coupler.

Pub. No. US 2018/0217322 A1 describes an attempted optical fiber filter for wideband deleterious light. The abstract of the '322 publication states that an FBG takes deleterious light out of a fiber core without reflecting it into the fiber core. It also allows the unhindered transmission of useful light at a wavelength outside of the spectral band covered by the deleterious light. The filter couples the incoming deleterious light to cladding modes propagating in the opposite direction without coupling the incoming useful light to core or cladding modes propagating in the opposite direction. The filter may for example be useful as a Raman or ASE filter in a laser cavity of other optical devices.

Alternatives external to the fiber might include optical coatings that limit the transmission of out-of-band power, but these can have their own limitations.

### SUMMARY OF THE DISCLOSURE

Filtering of parasitic processes in fiber optics is relatively new. Up to this point most implementations have used a single “strong” filter, which rejects nearly all of the energy at the parasitic wavelengths and passes nearly all of the energy at the desired laser wavelengths. The single “strong” filter approach has the disadvantage of needing to be appropriately thermally managed often due to interaction of the rejected energy with the fiber buffer and can be inefficient as it allows for the buildup of deleterious power prior to the filter itself.

Disclosed are distributed filters along the length of a fiber, which serve to repeatedly suppress parasitic processes. These filters, being distributed, can afford to be weaker (i.e., less reflective) individually, which presents several manufacturing advantages. In some embodiments, a weaker filter is one that reflects up to 20% of the nonlinear, or parasitic, laser component light.

In one aspect, a length of optical fiber for a fiber laser system configured to suppress a nonlinear optical process so as to inhibit energy transfer away from a desired laser wavelength, the length of optical fiber includes a core and a cladding configured to propagate a laser beam at the desired laser wavelength, alongside a nonlinear laser component having intensity that escalates as a function of distance due to the nonlinear optical process, a series of spaced-apart filters, each configured with a transmission level to redirect a proportion of the nonlinear laser component from the core into the cladding so as to collectively control exponential growth in the intensity of the nonlinear laser component by imparting resets in the intensity at predetermined intervals along the length, and an output configured to provide the laser beam following its suppressed escalation of the intensity and preservation of energy of the laser beam at the desired laser wavelength.

In one aspect, a method of suppressing a nonlinear optical process to inhibit energy transfer away from a desired laser wavelength includes several steps. First, guide a laser beam via a length of optical fiber, which comprises a core and cladding configured to propagate the beam at the desired wavelength alongside a nonlinear laser component. This component's intensity escalates with distance due to the nonlinear process. Next, repetitively filter this component with a series of spaced-apart filters, each set to a specific transmission level. These filters redirect a portion of the nonlinear component from the core into the cladding, thereby controlling exponential growth in intensity by resetting it at predetermined intervals. Finally, provide the laser beam from the output of the fiber, ensuring suppressed escalation of intensity and preserved energy at the desired wavelength.

In one aspect, a fiber laser system configured to suppress a nonlinear optical process so as to inhibit energy transfer away from a desired laser wavelength, includes a length of optical fiber having a core and a cladding, the core and cladding configured to propagate a laser beam at the desired laser wavelength, alongside a nonlinear laser component having intensity that escalates as a function of distance due to the nonlinear optical process, the length of optical fiber having a series of spaced-apart filters, each configured with a transmission level to redirect a proportion of the nonlinear laser component from the core into the cladding so as to collectively control exponential growth in the intensity of the nonlinear laser component by imparting resets in the intensity at predetermined intervals along the length, and the length of optical fiber having an output configured to provide the laser beam following its suppressed escalation of the intensity and preservation of energy of the laser beam at the desired laser wavelength, and one or more heatsinks configured to dissipate power in connection with the series of spaced-apart filters.

The fiber laser system may also include a master oscillator power amplifier (MOPA) having an active fiber, the active fiber includes the length of optical fiber.

The fiber laser system may also include a resonator having an active fiber, the active fiber includes the length of optical fiber.

The fiber laser system may also include fiber amplifier having an active fiber, the active fiber includes the length of optical fiber.

The fiber laser system may also include a MOPA, and in which the length of optical fiber is between an oscillator and an amplifier.

The fiber laser system may also include a signal combiner, and in which the length of optical fiber is before or after the signal combiner.

The length of optical fiber may also include each filter being spaced apart from neighboring filters by an equidistant amount.

The length of optical fiber may also include each filter being spaced apart from neighboring filters by decreasing amounts with respect to a propagation direction.

The length of optical fiber may also include the transmission level is configured to reflect 20% or less of the nonlinear laser component.

The length of optical fiber may also include the series of spaced-apart filters configured for SRS filtering.

The length of optical fiber may also include the series of spaced-apart filters configured for ASE filtering.

The length of optical fiber may also include the series of spaced-apart filters being tilted or chirped FBGs that back reflect the nonlinear laser component to a cladding light stripper.

The length of optical fiber may also include the series of spaced-apart filters being long period gratings (LPGs) that forward reflect the nonlinear laser component to a cladding light stripper.

The length of optical fiber may also include the series of spaced-apart filters being configured to direct the nonlinear laser component through the cladding.

The length of optical fiber may also include the optical fiber being a process fiber coupled to a process head.

The length of optical fiber may also include the optical fiber being a single-mode fiber.

The length of optical fiber may also include the optical fiber being a multi-mode fiber.

The length of optical fiber may also include the optical fiber being a doped fiber.

The length of optical fiber may also include the optical fiber being a passive fiber.

The length of optical fiber may be single, double, or triple-clad.

The effectiveness of this approach is demonstrated with a 2.2 kW, single-mode fiber laser system. The system features a single-mode (e.g., 14 μm core, 0.073 NA) delivery fiber measuring 10 meters. While examples provided pertain to this specific configuration, the principles of the technology are applicable to other delivery fiber configurations (e.g., multi-mode fibers) across various power levels, fiber laser systems (e.g., resonator only, MOPA configurations, or other fiber laser systems), and not restricted to the SRS process alone. The disclosed techniques are versatile, suitable for use in any fiber laser or fiber amplifier system and is not limited to the delivery fiber alone. Depending on the system design, it may be beneficial to implement distributed gratings in various sections of the laser architecture.

In essence, the utilization of multiple distributed filters throughout the fiber leads to several benefits: efficient suppression of parasitic processes, ensuring a low out-of-band power output; the potential to employ less intensive filters, compatible with draw tower fabrication methods; and a decrease in thermal stress on individual filters, which can enhance the durability and performance of the laser system.

This marks an advancement in the design and functionality of fiber laser systems, offering an efficient, adaptable solution to the challenge of parasitic light processes. Other technical features may be readily apparent to one skilled in the art from the following figures, description, and claims. The foregoing and other objects, features, and advantages will become more apparent from the following detailed description, which proceeds with reference to the accompanying figures, which may not be drawn to scale.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is an optical schematic of a 2.2 kW single-mode laser system with the optical spectrum displayed at the input to the 10 m long delivery fiber in accordance with one embodiment.

FIG. 2 is a plot showing the exponential growth of Raman power along the length of the delivery fiber, comparing the growth from the input spectrum at about 1.5 W of Raman seed power to the growth when the input is perfectly filtered (i.e., 0 W of Raman seed power) in accordance with one embodiment.

FIG. 3 is set of three side views of fibers with different numbers of SRS filters modeled with equidistant spacing along the 10 m delivery fiber length in accordance with one embodiment.

FIG. 4 is another side view of a double-clad fiber including three mutually spaced-apart SRS filters in accordance with one embodiment.

FIG. 5 are transmission vs. wavelength plots for the various filters used in models, with a left plot showing a linear y-axis scale while a right plot shows the same data on a log y-axis scale in accordance with one embodiment.

FIG. 6 is a plot showing the Raman power at the output of the 10 m delivery fiber vs. the filter transmission for the different number of filters in accordance with one embodiment.

FIG. 7 is a graph of SRS as a function of distance for a three-filter model in accordance with one embodiment.

FIG. 8 is a block diagram of a fiber laser system showing candidate locations of the SRS filters in accordance with one embodiment.

FIG. 9 is a block diagram of a fiber laser system showing candidate locations of the SRS filters in accordance with one embodiment.

FIG. 10 is a block diagram of a fiber laser system showing candidate locations of the SRS filters in accordance with one embodiment.

FIG. 11 is a block diagram of a fiber laser system showing candidate locations of the SRS filters in accordance with one embodiment.

FIG. 12 is a block diagram of a fiber laser system showing candidate locations of the SRS filters in accordance with one embodiment.

FIG. 13 is a flow chart of a process in accordance with one embodiment.

### DETAILED DESCRIPTION OF EMBODIMENTS

High-power laser systems, defined as those with an average power of at least 500 W, face significant challenges due to nonlinear optical effects such as Stimulated Raman Scattering (SRS). As the power of these systems increases, SRS and similar effects become more pronounced, which degrades the quality and power of the usable signal. Additionally, these nonlinear effects restrict the feasible length of the delivery fibers used to transmit the laser beam.

Historically, a 20-meter delivery fiber was adequate for most industrial laser applications. However, with advancements leading to even higher power systems, there is now a desire for longer delivery fibers, such as those reaching 50 meters. At these lengths, SRS becomes a critical design constraint such that new strategies are desired mitigate its impact.

One common approach to managing the issues caused by SRS and other nonlinear effects is the use of optical gratings. However, these gratings introduce insertion losses; for instance, a typical filter might have an insertion loss of 0.15 dB, equating to about a 3% signal loss per filter. Balancing these insertion losses with the need to manage SRS in long delivery fibers is a tradeoff in the development of efficient, high-power laser systems. Therefore, this disclosure describes techniques that can effectively mitigate SRS while optimizing for insertion losses, ensuring the system's performance remains optimal even with the extended fiber lengths and increased power levels.

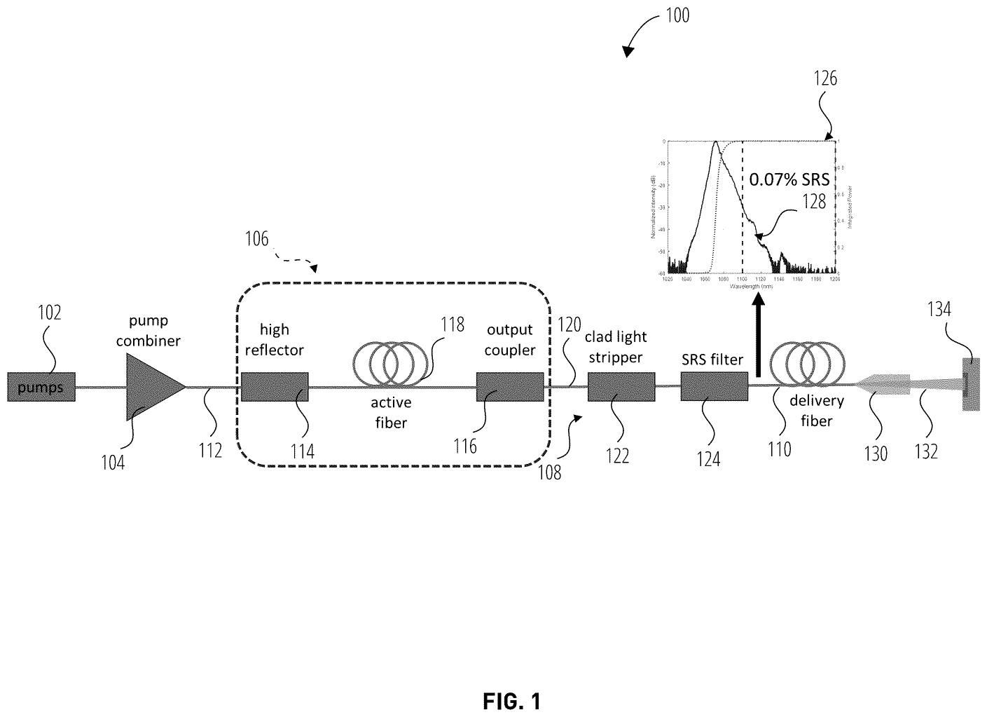

FIG. 1 shows an example of a 2.2 kW single-mode fiber laser system, denoted as system 100. In this configuration, system 100 incorporates pumps 102 and pump combiner 104; an oscillator or laser resonator 106; a set of passive fibers 108; and a 14 μm, 10 meter delivery fiber 110 (also referred to as a feeding fiber).

A delivery fiber refers to any optical fiber (or a length of fiber in set) designed to guide a laser beam, typically from the laser source to the point of use. This term is commonly used by tool integrators or end-users. A feeding fiber is an optical fiber assembly that is spliced to a laser, and typically featuring a connector at its output end. This connector is designed to plug into a socket on the input side of the processing optics, such as a cutting or welding head or a scanner. These optics format the laser beam and direct it to the workpiece. Alternatively, the beam from the feeding fiber can be launched into a process fiber, which is another optical fiber assembly equipped with connectors on both ends, linking the feeding fiber to the process optics.

Laser resonator 106 receives pump energy via a pump combiner output fiber 112 that is directed to a high reflection grating 114. This high reflection grating 114, together with an output coupler grating 116, establishes the main laser cavity, wherein light is subject to further amplification by a Yb-doped fiber 118. Output coupler grating 116 facilitates the exit of a specified percentage of the amplified light from the cavity.

Set of passive fibers 108 has integrated optical components for suppressing cladding light, dumping unabsorbed pump light, and filtering the SRS light generated from laser resonator 106. Set of passive fibers 108, comprising a fiber 120 that transports light from output coupler grating 116, include a cladding light stripper (CLS) 122. CLS 122 eliminates undesirable cladding light from fiber 120. Subsequent to CLS 122, SRS filter 124 is employed to constrain the amount of SRS seed light introduced into delivery fiber 110.

An optical spectrum diagram 126 demonstrates that with SRS filter 124 in place, SRS light 128 (quantified as the optical power at wavelengths beyond 1,100 nm) constitutes roughly 0.07% of the aggregate 2.2 kW output, or about 1.5 W.

For a comprehensive depiction, FIG. 1 also presents an end cap 130 situated at the termination of the delivery fiber 110, from which an optical beam 132 is emitted to interact with a process head (aperture) 134.

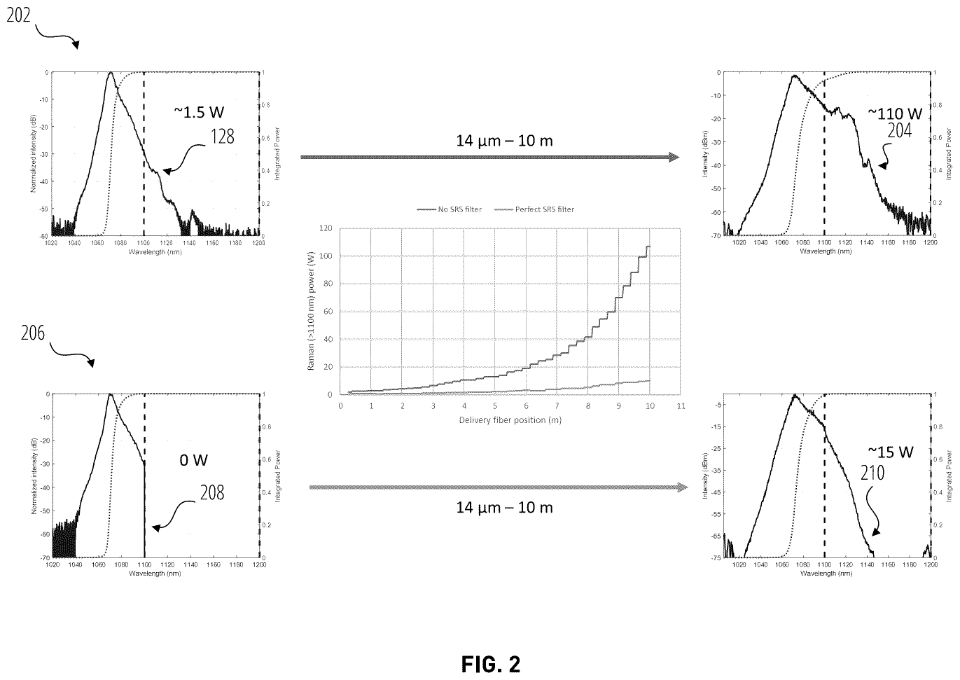

An upper portion 202 of FIG. 2 shows that, without any further mitigation of SRS light 128, this 1.5 W exponentially increases along the 10 m length of delivery fiber 110, resulting in increased SRS light 204 of approximately 110 W (about 5% of the 2.2 kW output power) at an output (e.g., end cap 130) of delivery fiber 110. An additional filter could be placed at the end of delivery fiber 110; however, this implementation would not be efficient as it would result in a 5% loss of the total laser power due to SRS conversion. Furthermore, a filter at the end of delivery fiber 110 would need to be heat sunk in some manner to appropriately handle the additional thermal load and not compromise the reliability of system 100.

Alternatively, a lower portion 206 of FIG. 2 shows that if SRS filter 124 were perfect (meaning that optical power 208 at wavelengths greater than 1,100 nm equaled 0 W), a parasitic SRS process still transfers power 210 away from the main laser wavelengths at an exponential rate resulting in about 15 W (about 0.7% of the 2.2 kW output power) at the fiber output (e.g., end cap 130).

Since a perfect filter is not possible, and with the goal of not wasting laser power by filtering at an end of delivery fiber 110, this disclosure presents a distributed filtering technique to efficiently achieve low SRS power at an output of delivery fiber 110.

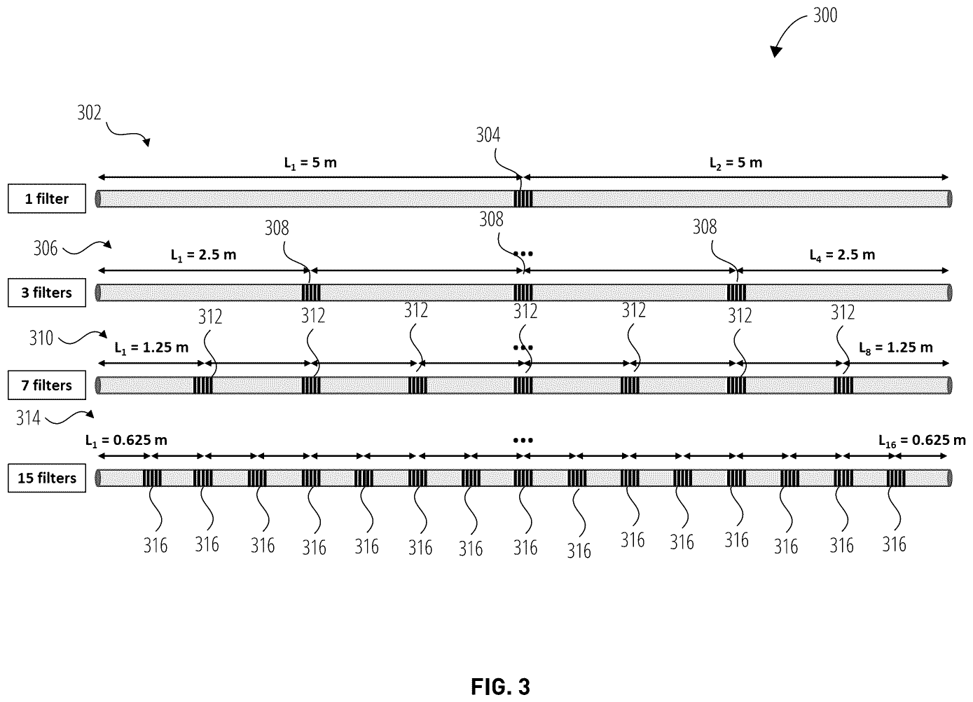

FIG. 3 shows four models 300 of distributed filters at equidistant spacing along 10 m delivery fiber lengths. A single-filter model 302 includes a single SRS filter 304 that is at a mid-point in its fiber. A three-filter model 306 includes three SRS filters 308, each spaced apart by 2.5 m from each other. A seven-filter model 310 includes seven SRS filters 312, each spaced apart by 1.25 m from each other. A 15-filter model 314 includes 15 SRS filters 316, each spaced apart by 0.625 m from each other. Since the filter spacing is on the order of meters, at that physical spacing the reflection peak spacing would be less than a picometer if the filters were acting like a SS-FG, which are imperceptible for the optical bandwidths of concern from the fiber laser.

The distributed filters direct parasitic light from the core into the cladding. In some embodiments, the rejected light is rejected through the cladding. In other embodiments, the rejected light is guided to a CLS upstream or downstream of the filter. Relatedly, as explained in more detail below, one or more heatsinks may be deployed at the location(s) of the filters or at a location of a CLS that is upstream or downstream of the filters. For instance, heatsinks on a filter may dissipate conductively transferred heat directly at a filter location, or heatsinks at a CLS may dissipate optical power by absorbing the filter light guided from the filter locations.

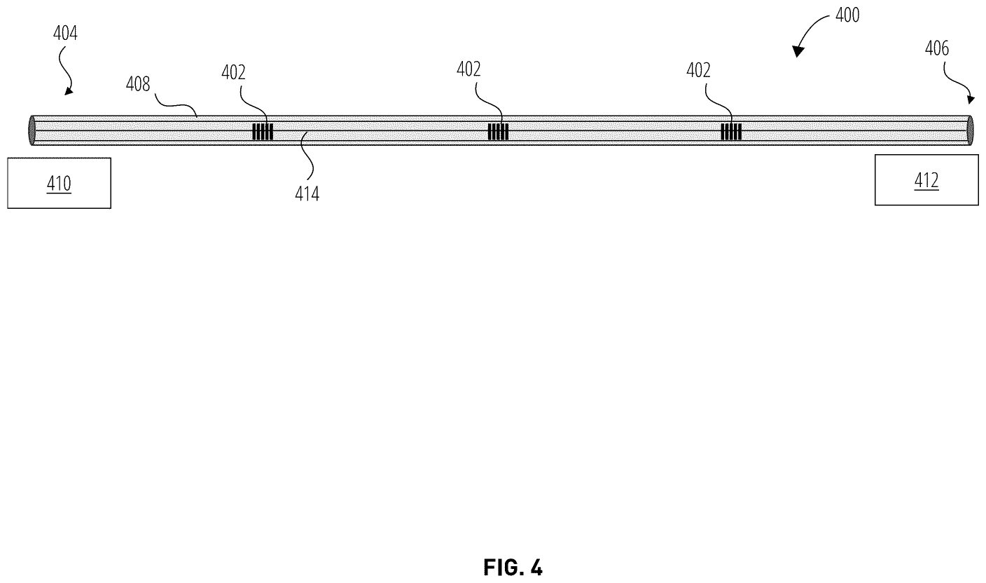

FIG. 4 shows a double-clad length of optical fiber 400 including multiple filters 402 between an input 404 and an output 406 (e.g., free ends, splices, or any other points at which fiber 400 receives or delivers a laser beam). In this example, parasitic light is reflected into an outer cladding 408 and guided towards a CLS (not shown) that is properly thermally managed to handle that power. Thus, once that light is confined in outer cladding 408. Depending on the type of filters used, the parasitic light is either directed towards input 404 (i.e., toward heatsink 410) or towards output 406 (i.e., toward heatsink 412).

Heatsink 410 and heatsink 412 are shown along fiber 400, but in other embodiments they may be located in another length of fiber (not shown) coupled to, respectively, input 404 or output 406, depending on design of filters 402. For instance, when filters 402 are LPG SRS filters, parasitic light is redirected out of core 414 and propagates forward toward heatsink 412. In another example, when filters 402 are FBGs, the parasitic light is back reflected towards heatsink 410. Skilled persons will appreciate in view of this disclosure that filters 402 themselves might be of various designs (chirped FBGs, tilted FBGs, LPGs, or other types of filters).

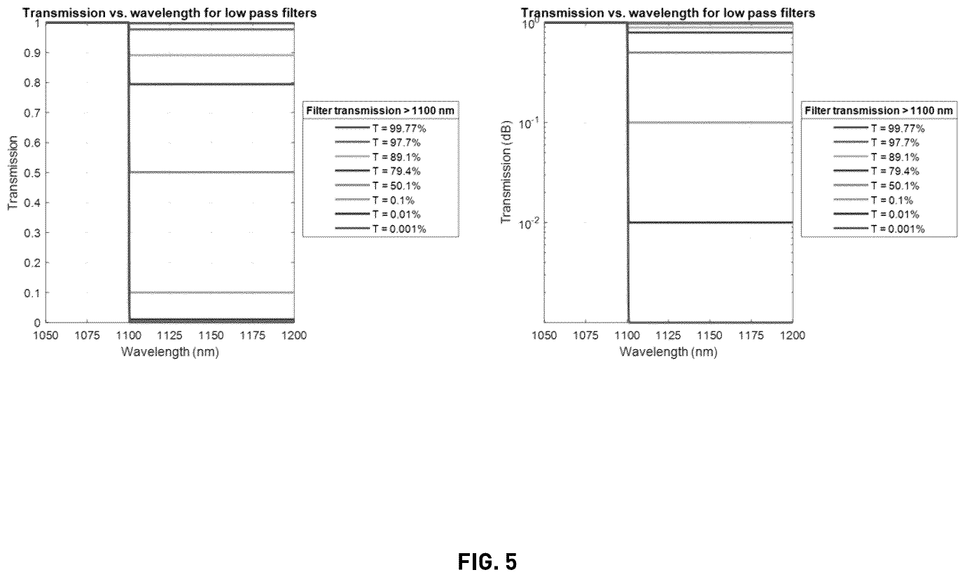

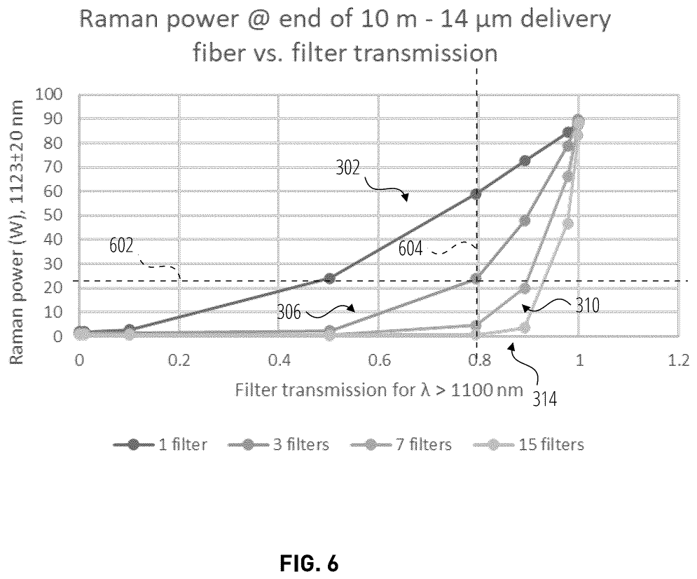

In some embodiments, each of the filters in a model along the length of a fiber have the same transmission (T). For instance, with models 300 of FIG. 3, simulations for all filters in a given model were run by varying the transmission from T equal to 1.0 (i.e., no filtering) to T equal to 0.001 (i.e., −30 dB of filtering), as shown in FIG. 5 and FIG. 6. It is assumed that the filter design is such that the rejected Raman power is coupled into the cladding and has little to no interaction with the other distributed filters along the length of a delivery fiber. For simplicity in the embodiments, the filters are realized as low pass filters with cutoff at 1,100 nm.

FIG. 5 shows an example of these filters' transmission vs. wavelength properties for both a linear and log scale. Though they are shown with a step-function, in practice, these filters presumably produce a transmission (or reflection) spectrum that is somewhat super-Gaussian in shape with a bandwidth of tens of nanometers wide.

The models shown in FIG. 3 are used to generate simulation results represented in FIG. 6, which displays the integrated Raman power within the range of 1,103 to 1,143 nm at the output of the 10-meter feeding fiber. This data is charted against varying transmission rates for the individual filters. It is observed that as the number of filters increases along the length of the feeding fiber, the transmission of the individual filters can be increased (or alternatively the reflectivity of the filters can be decreased) to maintain a low Raman power at the output of the feeding fiber.

In an example application, up to approximately 1% of the output power as SRS may be acceptable (equating to about 22 W for a 2.2 kW laser). This criterion is marked by a dashed line 602 in the figure. Within this framework, individual filter transmissions can be adjusted up to 80%, as indicated by a dashed line 604 for three, seven, and fifteen filter models denoted by 306, 310, and 314. These simulations suggest that the deployment of as few as three “weak” filters across the 10-meter fiber length can meet the target Raman power output. However, a greater number of filters placed in closer proximity can further curtail Raman power and afford greater leeway in manufacturing processes. The adoption of weaker filters also substantially cases the thermal management demands on the gratings.

The approach of utilizing relatively “weak” filters with high transmission facilitates the integration of these filters directly into the optical fiber during the draw process. With current draw tower FBG writing technology, achieving a reflectivity of approximately 20%—corresponding to 80% transmission—is assumed to be within reach. However, writing gratings adequate for Raman filtering, or those tilted to ensure cladding coupling, may entail some modification beyond standard draw tower grating specifications. If filters are inscribed during the fiber draw, one could manufacture an entire spool of feeding fiber pre-equipped with distributed filters. Consequently, the fiber delivery manufacturing and deployment processes are streamlined, allowing for the simple cutting of required fiber lengths without having to consider the precise positions of the filters.

In other embodiments, an array of filters could also be fabricated using a non-draw tower method. For instance, a “spool-to-spool” system may be used to fabricate them post draw. Other methods of translating the fiber or writing source are also possible.

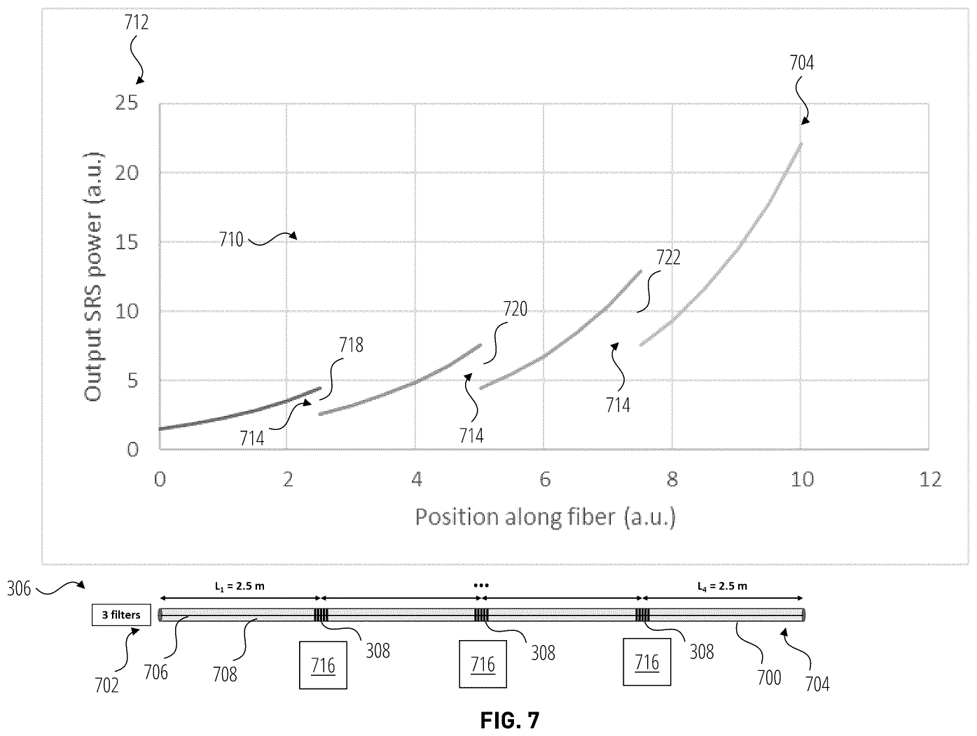

FIG. 7 shows three-filter model 306 and a simulation of its SRS suppression as a function of distance. As explained previously, a length of optical fiber 700 is configured to suppress a nonlinear optical process so as to inhibit energy transfer away from a desired laser wavelength.

Length of optical fiber 700 includes an input 702, an output 704, a core 706, and a cladding 708. Core 706 and cladding 708 are configured to guide a laser beam (see beam 132, FIG. 1) having the desired laser wavelength and a nonlinear laser component 710 that increases as a function of distance. In other embodiments, a length of optical fiber may have double, triple, or more claddings.

Filters 308 are spaced-apart to perturb the laser beam in core 706. Members in this set of filters 308 have a transmission level configured to redirect a proportion of nonlinear laser component 710 away from core 414 into cladding 708 so as to collectively control exponential growth in intensity 712 of nonlinear laser component 710 by imparting resets 714 in intensity 712 at predetermined intervals along the length. A designer may select the intervals, in accordance with the transmission levels, heatsink configuration, and other desired performance specifications.

Output 704 is configured to provide the laser beam following its suppressed escalation of intensity 712 and preservation of energy of the laser beam at the desired laser wavelength.

Through this systematic filtering, length of optical fiber 700 ensures that any exponential increase in nonlinear laser component 710 is repetitively reset, maintaining the process intensity within desirable limits and preserving the integrity and efficiency of the laser output. Moreover, each optional heatsink 716 can be configured to dissipate a small, stepwise increase in power. In this example, there is a first filter amount 718 of about 1.8 W, a second filter amount 720 of about 3.1 W, and a third filter amount 722 of 5.3 W. This leaves about 22 W to handle at output 704 (for a total loss of about 22 W, or 1%).

Skilled persons will also appreciate that the filters themselves need not be equidistantly spaced apart. For instance, because SRS losses tend to increase, filters may be placed at progressively closer distances. In one example, the filters are arranged so that thermal loads or losses at any given filter is similar (e.g., ±40%) to that at other filters.

In the example of a single cladding fiber, or a filter that directs the nonlinear light through the cladding, individual heatsinks 716 allow dissipation of heat at a location near each filter. This is useful because heat can build up at a polymer coating (not shown) due to interaction of the light with the often absorbing, higher refractive index, protective polymer. In the case where the deleterious light has been coupled from the core and through the cladding, individual heatsinks may be advantageous to control the management of that power in a way as to not be harmful to the rest of the laser system. Some filter schemes may also attenuate the light at the point of the filter, in which case thermal management at the filter would be desirable.

In other embodiments, rather than having individual heatsinks, a single heatsink may extend across multiple filters that are optionally potted in thermally conducting material.

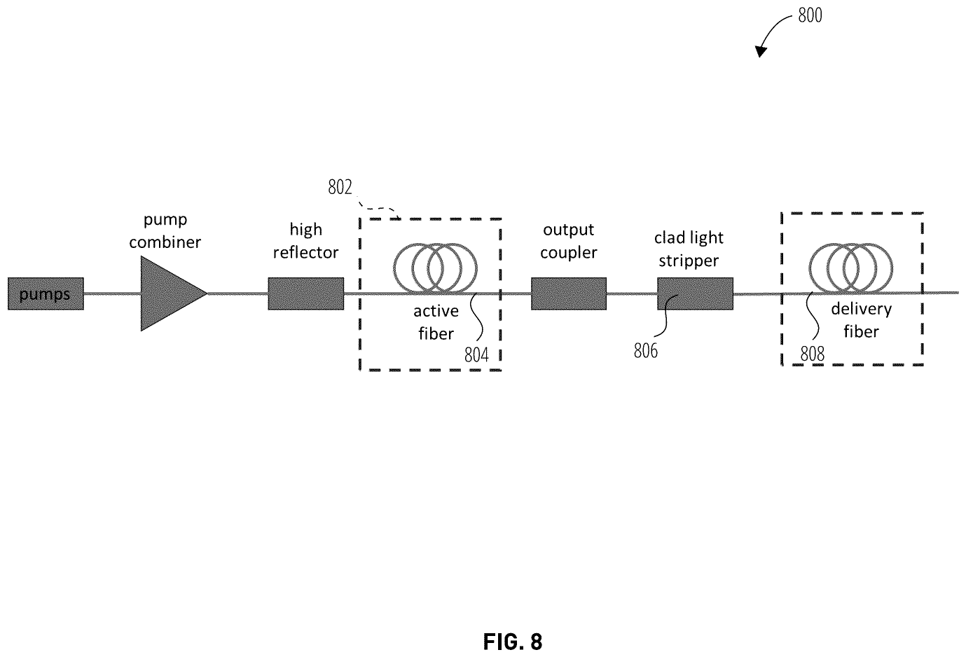

The previously described arrays of filters may be deployed at different locations in various fiber laser systems. For instance, FIG. 8-FIG. 12 show examples of locations in different systems. In these figures, filter arrays may be deployed anywhere within the dashed boxes, recognizing that the nonlinear effects may increase as a function of distance.

FIG. 8 shows a fiber laser system 800 including a resonator 802 and other components similar to those shown in FIG. 1. In this configuration, the array of filters may be deployed as part of an active fiber 804 of resonator 802. Active fiber 804 is a doped fiber that may be doped with Yb, Er, Tm, Nd, Yb: Er, or any number of dopants.

When the array of filters is included in active fiber 804, rejected light can be directed to CLS 806 (i.e., with a heatsink) for accepting the rejected parasitic light. The fiber in this example is double or triple clad so as to guide the filtered light to CLS 806. Furthermore, in this example, the filters in active fiber 804 are LPGs so as to project the light in the forward direction towards CLS 806.

In another embodiment, the array may be deployed as part of a delivery fiber 808 downstream from laser resonator 802. In this example, filters in delivery fiber 808 are FBGs to reflect the light back to CLS 806.

In other embodiments, heatsinks may be deployed directly at the filters themselves (rather than upstream or downstream from the filters). In this configuration, filters in active fiber 804 are more straightforward to heatsink because they are typically internal to the laser system where there are already mechanical locations available to deploy heatsinks, and an active fiber is likely already heatsunk due to the pump or laser process having heat-control specifications. Conversely, it may be more challenging to heatsink the feeding fiber, e.g., if delivery fiber 808 is coupled to a tool that moves and bends the fiber.

In other embodiments, a filter array may be placed in both active fiber 804 and delivery fiber 808.

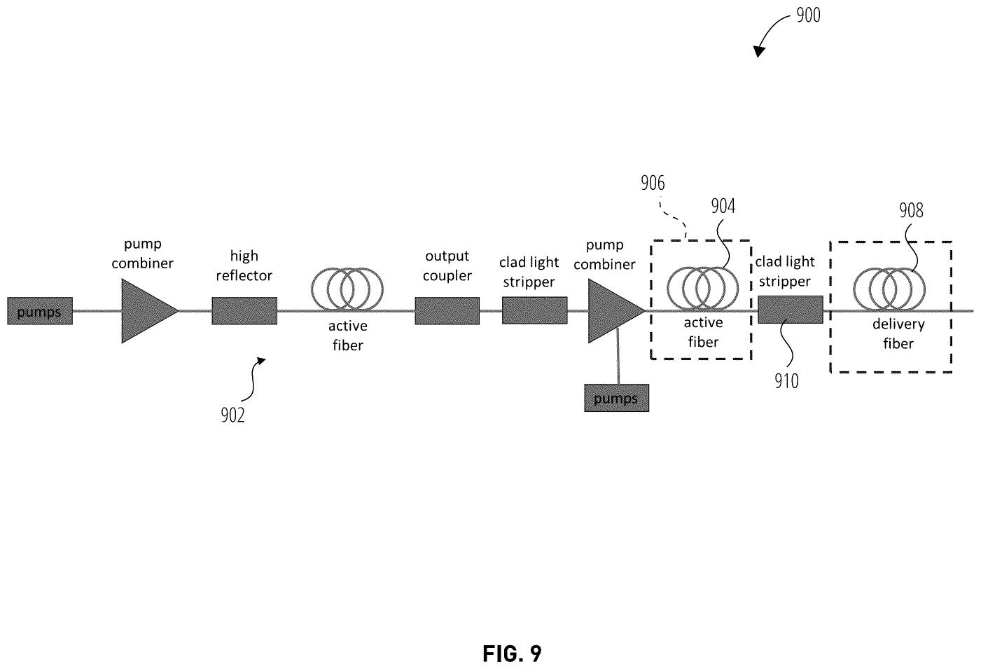

FIG. 9 shows a fiber laser system 900 including a laser MOPA 902. In this configuration, the array of filters may be deployed as part of an active fiber 904 of an amplifier 906, which as explained previously, is straightforward to heatsink.

In addition to or in lieu of a filter array in active fiber 904, the filter array may be deployed as a part of a delivery fiber 908 coupled to laser MOPA 902, with the appropriately designed heatsink (not shown), e.g., to direct the light back to a CLS 910 with a heatsink.

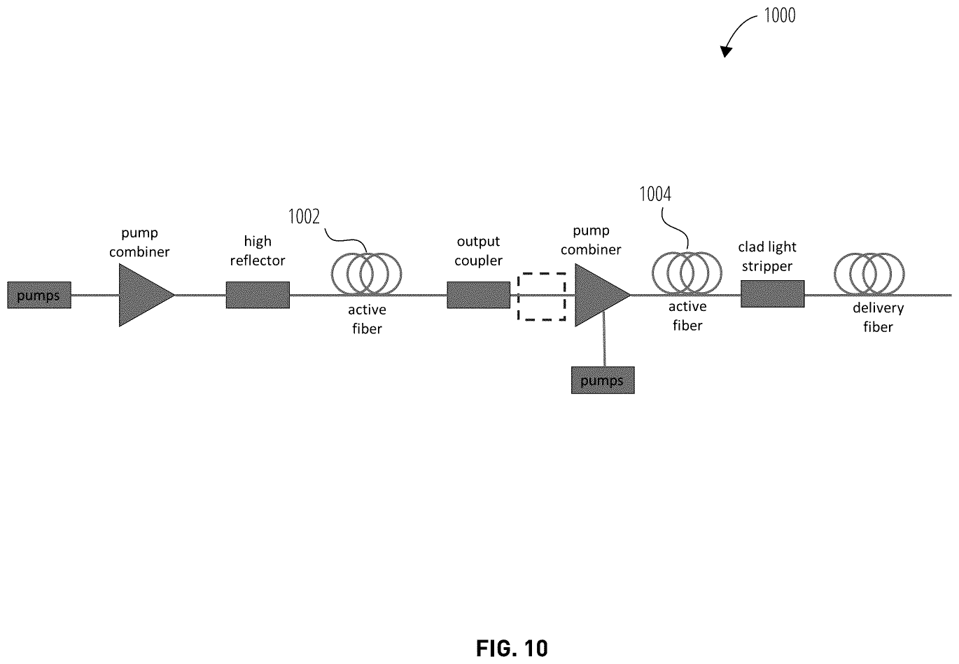

FIG. 10 shows a fiber laser system 1000, similar to fiber laser system 900, but in which a filter array is deployed between an oscillator 1002 and an amplifier 1004. The example would also be straightforward to heatsink because the array is internal to fiber laser system 1000.

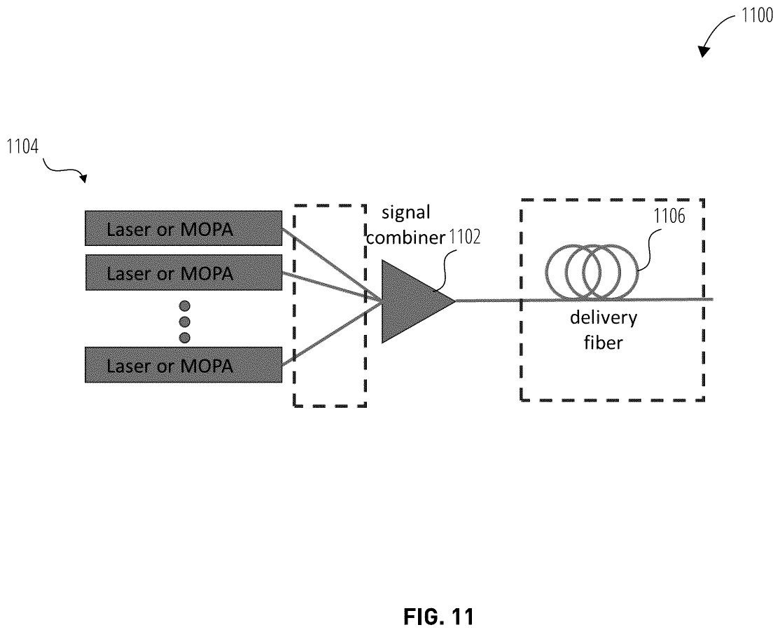

FIG. 11 shows a fiber laser system 1100 with a signal combiner 1102 to combine multiple lasers or MOPAs 1104. In this example, a filter array may be placed before signal combiner 1102, at each input, with multiple heatsinks depending on the architecture. As in all the other examples, a filter array may also be placed in a delivery fiber 1106, after signal combiner 1102.

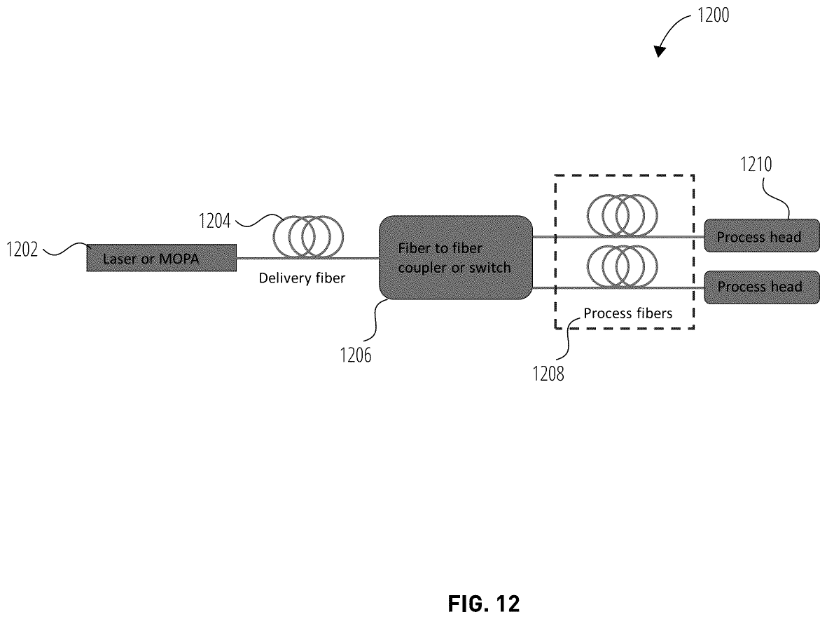

FIG. 12 shows a fiber laser system 1200 with a laser or MOPA 1202, a delivery fiber 1204, a fiber-to-fiber coupler or switch 1206, process fibers 1208, and a process head 1210. In this embodiment, a filter array may be placed in one or both process fibers 1208.

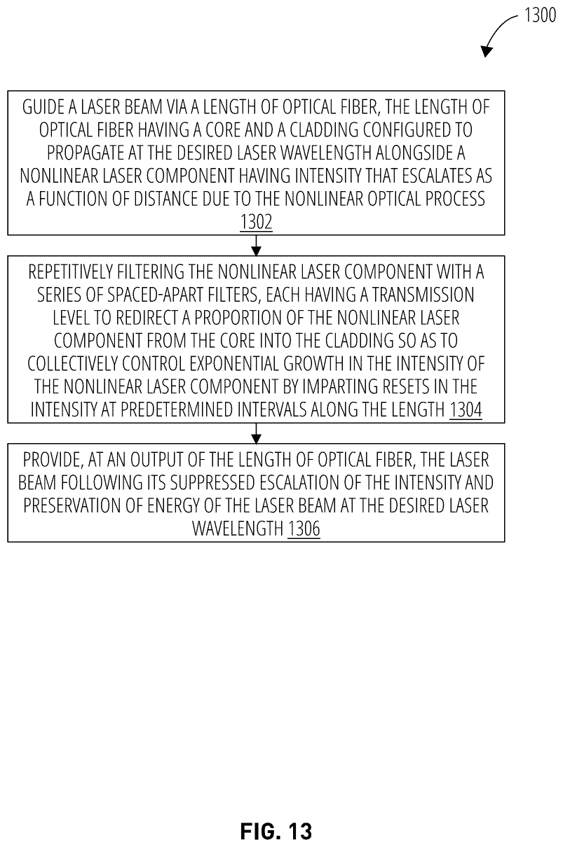

FIG. 13 shows a process 1300, performed by a length of optical fiber, of suppressing a nonlinear optical process so as to inhibit energy transfer away from a desired laser wavelength. In block 1302, process 1300 entails guiding a laser beam via a length of optical fiber, the length of optical fiber having a core and a cladding configured to propagate at the desired laser wavelength alongside a nonlinear laser component having intensity that escalates as a function of distance due to the nonlinear optical process. In block 1304, process 1300 entails repetitively filtering the nonlinear laser component with a series of spaced-apart filters, each having a transmission level to redirect a proportion of the nonlinear laser component from the core into the cladding so as to collectively control exponential growth in the intensity of the nonlinear laser component by imparting resets in the intensity at predetermined intervals along the length. In block 1306, process 1300 entails providing, at an output of the length of optical fiber, the laser beam following its suppressed escalation of the intensity and preservation of energy of the laser beam at the desired laser wavelength.

### Concluding Remarks

Skilled persons will appreciate that many changes may be made to the details of the above-described embodiments without departing from the underlying principles of the invention. The scope of the present invention should, therefore, be determined only by the following claims.

What is claimed is:

1. A length of optical fiber for a fiber laser system configured to suppress a nonlinear optical process so as to inhibit energy transfer away from a desired laser wavelength, the length of optical fiber comprising:
a core and a cladding configured to propagate a laser beam at the desired laser wavelength, alongside a nonlinear laser component having intensity that escalates as a function of distance due to the nonlinear optical process;
a series of spaced-apart filters, each configured with a transmission level to redirect a proportion of the nonlinear laser component from the core into the cladding so as to collectively control exponential growth in the intensity of the nonlinear laser component by imparting resets in the intensity at predetermined intervals along the length; and
an output configured to provide the laser beam following its suppressed escalation of the intensity and preservation of energy of the laser beam at the desired laser wavelength.

2. A method of suppressing a nonlinear optical process so as to inhibit energy transfer away from a desired laser wavelength, the method comprising:
guiding a laser beam via a length of optical fiber, the length of optical fiber having a core and a cladding configured to propagate at the desired laser wavelength alongside a nonlinear laser component having intensity that escalates as a function of distance due to the nonlinear optical process;
repetitively filtering the nonlinear laser component with a series of spaced-apart filters, each having a transmission level to redirect a proportion of the nonlinear laser component from the core into the cladding so as to collectively control exponential growth in the intensity of the nonlinear laser component by imparting resets in the intensity at predetermined intervals along the length; and
providing, at an output of the length of optical fiber, the laser beam following its suppressed escalation of the intensity and preservation of energy of the laser beam at the desired laser wavelength.

3. A fiber laser system configured to suppress a nonlinear optical process so as to inhibit energy transfer away from a desired laser wavelength, comprising:
a length of optical fiber having a core and a cladding, the core and cladding configured to propagate a laser beam at the desired laser wavelength, alongside a nonlinear laser component having intensity that escalates as a function of distance due to the nonlinear optical process, the length of optical fiber having a series of spaced-apart filters, each configured with a transmission level to redirect a proportion of the nonlinear laser component from the core into the cladding so as to collectively control exponential growth in the intensity of the nonlinear laser component by imparting resets in the intensity at predetermined intervals along the length, and the length of optical fiber having an output configured to provide the laser beam following its suppressed escalation of the intensity and preservation of energy of the laser beam at the desired laser wavelength; and
one or more heatsinks configured to dissipate power in connection with the series of spaced-apart filters.

4. The fiber laser system of claim 3, including a MOPA having an active fiber, the active fiber comprising the length of optical fiber.

5. The fiber laser system of claim 3, including a resonator having an active fiber, the active fiber comprising the length of optical fiber.

6. The fiber laser system of claim 3, including fiber amplifier having an active fiber, the active fiber comprising the length of optical fiber.

7. The fiber laser system of claim 3, including a MOPA, and in which the length of optical fiber is between an oscillator and an amplifier.

8. The fiber laser system of claim 3, including a signal combiner, and in which the length of optical fiber is before the signal combiner.

9. The fiber laser system of claim 3, including a signal combiner, and in which the length of optical fiber is after the signal combiner.

10. The length of optical fiber of claim 1, in which each filter is spaced apart from neighboring filters by an equidistant amount.

11. The length of optical fiber of claim 1, in which each filter is spaced apart from neighboring filters by decreasing amounts with respect to a propagation direction.

12. The length of optical fiber of claim 1, the transmission level is configured to reflect 20% or less of the nonlinear laser component.

13. The length of optical fiber of claims 1, in which the series of spaced-apart filters are configured for SRS filtering.

14. The length of optical fiber of claim 1, in which the series of spaced-apart filters are configured for ASE filtering.

15. The length of optical fiber of claim 1, in which the series of spaced-apart filters are tilted or chirped FBGs that back reflect the nonlinear laser component to a cladding light stripper.

16. The length of optical fiber of claim 1, in which the series of spaced-apart filters are LPGs that forward reflect the nonlinear laser component to a cladding light stripper.

17. The length of optical fiber of claim 1, in which in which the series of spaced-apart filters are configured to direct the nonlinear laser component through the cladding.

18. The length of optical fiber of claim 1, in which the optical fiber is a process fiber coupled to a process head.

19. The length of optical fiber of claim 1, in which the optical fiber is a single-mode fiber.

20. The length of optical fiber of claim 1, in which the optical fiber is a multi-mode fiber.

21. The length of optical fiber of claim 1, in which the optical fiber is a doped fiber.

22. The length of optical fiber of claim 1, in which the optical fiber is a passive fiber.

23. The length of optical fiber of any one of claim 1, in which the optical fiber is a single, double, or triple clad fiber.
